(19) United States
(12) Patent Application Publication
(10) Pub. No.: US 2021/0165292 A1
(43) Pub. Date: Jun. 3, 2021

(54) DISPLAY PANEL AND DISPLAY APPARATUS USING SAME

(71) Applicant: HKC Corporation Limited, Shenzhen City, Guangdong (CN)

(72) Inventor: Beizhou HUANG, Shenzhen City, Guangdong (CN)

(21) Appl. No.: 16/068,231

(22) PCT Filed: Dec. 19, 2017
(86) PCT No.: PCT/CN2017/117076

§ 371 Date: Jul. 5, 2018

(30) Foreign Application Priority Data
Nov. 3, 2017 (CN) 201711072896.4

(51) Int. Cl. G02F 1/1362; G02F 1/1368

(52) U.S. Cl. CPC G02F 1/136286; G02F 1/1368; G02F 1/136222; G02F 1/136209

(57) ABSTRACT

This application provides a display panel, includes: a first substrate and a second substrate disposed opposite to each other; a active switches, disposed on the first substrate; a conductive lines, disposed on the first substrate, where a (2n−1)^{th} conductive line is disposed adjacent to a 2n^{th} conductive line, the 2n^{th} conductive line is disposed away from a (2n+1)^{th} conductive line; a color filter layer, including a pixel groups disposed on the first or second substrate, where each pixel group includes a adjacent color filter units having different colors; and a light shielding layer, disposed between the color filter units, where the light-shielding layer separates the color filter units; adjacent color filter units of adjacent pixel groups have a same color; and a distance between the 2n^{th} conductive line and the (2n+1)^{t} conductive line is longer than a distance between the (2n−1)^{th} conductive line and the 2n^{th} conductive line.

### BACKGROUND

### Technical Field

This application relates to the display field, and in particular, to a display panel and a display apparatus using same.

### Related Art

Liquid crystal display apparatuses have many advantages such as thin structure, power saving, and no radiation, and are widely applied in recent years. Most of liquid crystal display apparatuses in the existing market are backlit liquid crystal display apparatuses including liquid crystal panels and backlight modules. The working principle of the liquid crystal panel is: Liquid crystal molecules are placed between two parallel glass substrates, and a drive voltage is applied to the two glass substrates to control a rotation direction of the liquid crystal molecules, so as to refract light from the backlight module to produce an image.

Currently, active switch type liquid crystal display apparatuses (Thin Film Transistor-Liquid Crystal Display, TFT-LCD) have gradually occupied a leading position in the display field because of the performance such as low power consumption, high image quality, and the relatively high production yield. Likewise, the active switch type liquid crystal display apparatus include a liquid crystal panel and a backlight module. The liquid crystal panel includes a color filter (CF) substrate and an active switch array substrate (Thin Film Transistor Substrate, TFT substrate). Transparent electrodes exist at opposite inner sides of the substrates.

After a display panel is designed according to a pixel architecture, a light shielding layer needs to be added to avoid light leakage. The light shielding layer shields leaked light of a data line and a scanning line. However, when the light shielding layer is used to shield light, the aperture ratio is affected. However, as the requirement for display panels becomes higher, resolutions of the display panels become higher, the area of a color resist unit becomes smaller, and the aperture ratio becomes lower. Consequently, brightness needs to be provided by a backlight module. This consumes power and is not environmentally friendly.

### SUMMARY

To resolve the foregoing technical problem, an objective of this application is to provide a display panel and a display apparatus using same. In this application, by means of configuration of data lines and scanning lines and an arrangement design of color filter units, an area ratio of a black matrix layer to a display panel can be reduced, thereby improving an aperture ratio and a display effect of the display panel.

The objective of this application is achieved and the technical problem of this application is resolved by using the following technical solutions. A display panel provided according to this application comprises: a first substrate, where a plurality of active switches are disposed on the first substrate; a second substrate, disposed opposite to the first substrate; a plurality of conductive lines, disposed on the first substrate, where a (2n−1)^{th} conductive line is disposed adjacent to a 2n^{th} conductive line, the 2n^{th} conductive line is disposed away from a (2n+1)^{th} conductive line, and n is a positive number; a color filter layer, comprising a plurality of pixel groups disposed on the first substrate or the second substrate, where each pixel group comprises a plurality of adjacent color filter units having different colors; and a light shielding layer, disposed between the color filter units and covering the conductive lines, where the light-shielding layer separates the color filter units; wherein adjacent color filter units of adjacent pixel groups have a same color; and wherein a distance between the 2n^{th} conductive line and the (2n+1)^{th} conductive line is longer than a distance between the (2n−1)^{th} conductive line and the 2n^{th} conductive line.

Further, the objective of this application may be achieved and the technical problem of this application may be resolved by using the following technical solutions.

In an embodiment of this application, the conductive lines comprise a plurality of scanning lines coupled to a gate driver.

In an embodiment of this application, a plurality of light-transmitting regions is formed in a direction of the scanning lines and in a direction perpendicular to the scanning lines on the light shielding layer, and each light-transmitting region comprises two color filter units, where a 4x^{th} color filter unit and a (4x+1)^{th} color filter unit along the scanning line have a same color and are located in a same light-transmitting region, and x is a positive number.

In an embodiment of this application, the conductive lines comprise a plurality of data lines coupled to a source driver.

In an embodiment of this application, a plurality of light-transmitting regions is formed in a direction of the data lines and in a direction perpendicular to the data lines on the light shielding layer, and each light-transmitting region comprises two color filter units, where a 4y^{th} color filter unit and a (4y+1)^{th} color filter unit along the data line have a same color and are located in a same light-transmitting region, and y is a positive number.

In an embodiment of this application, the conductive lines comprise a plurality of scanning lines coupled to a gate driver and a plurality of data lines coupled to a source driver.

In an embodiment of this application, a plurality of light-transmitting regions is formed in a direction of the scanning lines and in a direction of the data lines on the light shielding layer, and each light-transmitting region comprises four color filter units, where a 4x^{th} color filter unit and a (4x+1)^{th} color filter unit along the scanning line have a same color or a 4y^{th} color filter unit and a (4y+1)^{th} color filter unit along the data line have a same color, and the four color filter units are located in a same light-transmitting region, where x and y are positive numbers.

In an embodiment of this application, no light shielding layer is disposed between adjacent color filter units having a same color.

In an embodiment of this application, adjacent pixel groups are mirror symmetrical.

In an embodiment of this application, a material of the light shielding layer is a dark light-absorbing material or a low reflective material.

In an embodiment of this application, the light shielding layer is a black matrix.

Another objective of this application is to provide a display apparatus, comprising a control element and the foregoing display panel.

Still another objective of this application is to provide a display panel, comprising: a first substrate, where a plurality of active switches are disposed on the first substrate; a second substrate, disposed opposite to the first substrate; a plurality of conductive lines, disposed on the first substrate, where a (2n−1)^{th} conductive line is disposed adjacent to a 2n^{th} conductive line, the 2n^{th} conductive line is disposed away from a (2n+1)^{th} conductive line, and n is a positive number; a color filter layer, comprising a plurality of pixel groups disposed on the first substrate or the second substrate, where each pixel group comprises a plurality of adjacent color filter units having different colors; and a light shielding layer, disposed between the color filter units and covering the conductive lines, where the light-shielding layer separates the color filter units; wherein adjacent color filter units of adjacent pixel groups have a same color; wherein a distance between the 2n^{th} conductive line and the (2n+1)^{th} conductive line is longer than a distance between the (2n−1)^{th} conductive line and the 2n^{th} conductive line; color filter units in each pixel group are sequentially horizontally or vertically arranged along the conductive lines; the pixel group comprises a red color filter unit, a green color filter unit, a blue color filter unit, and a white color filter unit disposed in an array, and adjacent pixel groups are mirror symmetrical; and a material of the light shielding layer is a dark light-absorbing material or a low reflective material.

In this application, by means of configuration of data lines and scanning lines and an arrangement design of color filter units, an area ratio of a black matrix layer to a display panel can be reduced, thereby improving an aperture ratio and a display effect of the display panel.

### BRIEF DESCRIPTION OF THE DRAWINGS

FIG. 1a is a schematic diagram of an exemplary pixel circuit;

FIG. 1b is a schematic diagram of an exemplary color filter layer;

FIG. 2 is a schematic diagram of a pixel circuit according to an embodiment of this application;

FIG. 3 is a schematic diagram of a color filter layer according to an embodiment of this application;

FIG. 4 is a schematic diagram of a pixel circuit according to another embodiment of this application;

FIG. 5 is a schematic diagram of a color filter layer according to another embodiment of this application;

FIG. 6 is a schematic diagram of a pixel circuit according to still another embodiment of this application;

FIG. 7 is a schematic diagram of a color filter layer according to still another embodiment of this application;

FIG. 8 is a schematic diagram of a pixel circuit according to an embodiment of this application;

FIG. 9 is a schematic diagram of a color filter layer according to an embodiment of this application;

FIG. 10 is a schematic diagram of a pixel circuit according to another embodiment of this application;

FIG. 11 is a schematic diagram of a color filter layer according to another embodiment of this application;

FIG. 12 is a schematic diagram of a pixel circuit according to still another embodiment of this application;

FIG. 13 is a schematic diagram of a color filter layer according to still another embodiment of this application;

FIG. 14 is an extended schematic diagram of the color filter layer in FIG. 13; and

FIG. 15 is a block diagram of a display apparatus according to an embodiment of this application.

### DETAILED DESCRIPTION

The following embodiments are described with reference to the accompanying drawings, which are used to exemplify specific embodiments for implementation of this application. Direction terms mentioned in this application, such as “on”, “below”, “front”, “back”, “left”, “right”, “in”, “out”, and “side” merely refer to directions in the accompanying drawings. Therefore, the direction terms used are for the purpose of describing and understanding this application, and are not intended to limit this application.

The accompanying drawings and the description are considered to be essentially exemplary, rather than limitative. In the figures, units with similar structures are represented by using the same reference number. In addition, for understanding and ease of description, the size and the thickness of each component shown in the accompanying drawings are arbitrarily shown, but this application is not limited thereto.

In the accompanying drawings, for clarity, thicknesses of a layer, a film, a panel, a region, and the like are enlarged. In the accompanying drawings, for understanding and ease of description, thicknesses of some layers and regions are enlarged. It should be understood that when a component such as a layer, a film, a region, or a substrate is described to be “on” another component, the component may be directly on the another component, or there may be an intermediate component.

In addition, in the specification, unless otherwise explicitly described to have an opposite meaning, the word “include” is understood as including the component, but not excluding any other component. In addition, in the specification, “on” means that one is located above or below a target component and does not necessarily mean that one is located on the top based on a gravity direction.

To further describe the technical means adopted in this application to achieve the preset inventive objective and effects thereof, specific implementations, structures, features, and effects of a display panel and a display apparatus using same provided according to this application are described below in detail with reference to the accompanying drawings and preferred embodiments.

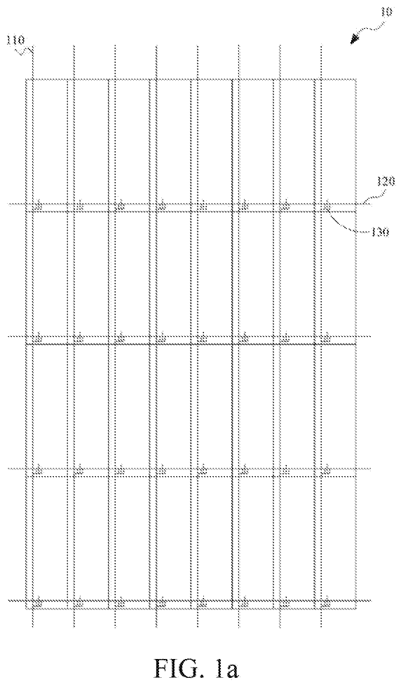

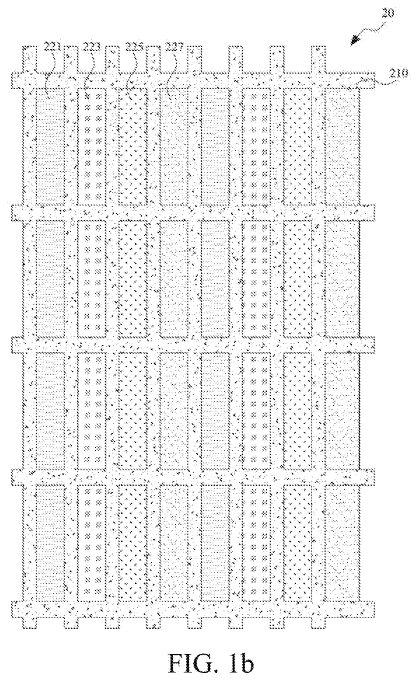

FIG. 1a is a schematic diagram of an exemplary pixel circuit, and FIG. 1b is a schematic diagram of an exemplary color filter layer. Referring to both FIG. 1a and FIG. 1b, an exemplary display panel includes: a pixel circuit 10; a plurality of data lines 110; a plurality of scanning lines 120; a plurality of active switches 130, for example, thin film transistor switches, correspondingly connected to the data lines 110 and the scanning lines 120 respectively, where the data lines 110 are interlaced with the scanning lines 120 to define a plurality of light-transmitting regions; a color filter layer 20, including a plurality of pixel groups, where each pixel group includes a plurality of color filter units having different colors, for example, RGBW color filter units (221, 223, 225, and 227); and a light shielding layer 210, disposed between the plurality of color filter units (221, 223, 225, and 227), to separate the color filter units having different colors. However, because the light shielding layer 210 needs to shield leaked light of the data lines 110 and the scanning lines 120, an aperture ratio of the color filter unit may be affected. In addition, as a resolution of the display panel increases, the area of the color filter unit becomes smaller, but an area ratio of the light shielding layer 210 shielding leaked light of the data lines 110 and the scanning lines 120 is not correspondingly reduced, leading to a lower aperture ratio of the color filter unit.

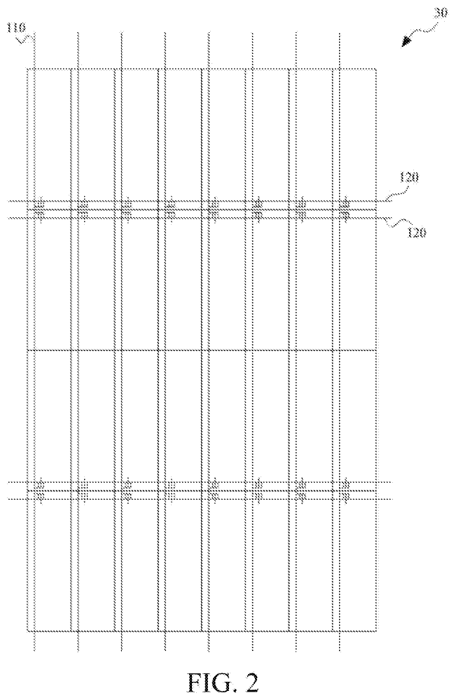

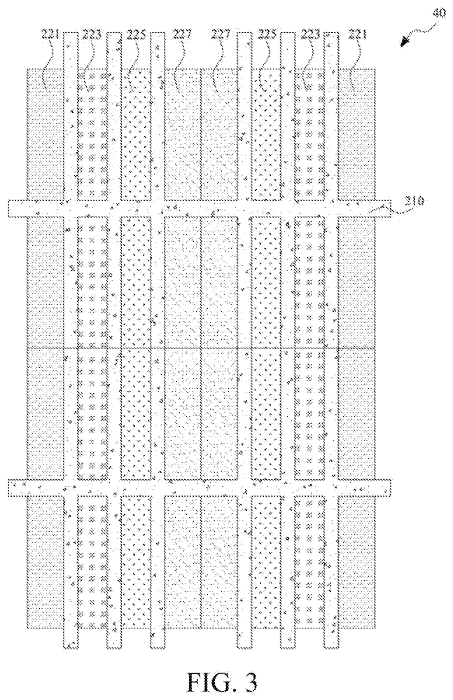

FIG. 2 is a schematic diagram of a pixel circuit according to an embodiment of this application, and FIG. 3 is a schematic diagram of a color filter layer according to an embodiment of this application. Referring to FIG. 2 and FIG. 3, in an embodiment of this application, a display panel includes: a first substrate (not shown); a second substrate (not shown), disposed opposite to the first substrate; a pixel circuit 30, including a plurality of conductive lines disposed on the first substrate, where a (2n−1)^{th} conductive line is disposed adjacent to a 2n^{th} conductive line, the 2n^{th} conductive line is disposed away from a (2n+1)^{th} conductive line, and n is a positive number; a color filter layer 40, including a plurality of pixel groups disposed in an array on the first substrate or the second substrate, where each pixel group includes a plurality of adjacent color filter units having different colors, and the color filter units are strip-shaped color resistors; and a light shielding layer 210, disposed between the color filter units and covering the conductive lines, where the light shielding layer 210 separates the plurality of color filter units. The conductive lines include a plurality of scanning lines 120 coupled to a gate driver.

In some embodiments, adjacent color filter units of adjacent pixel groups have a same color.

In some embodiments, each pixel group includes a red color filter unit 221, a green color filter unit 223, a blue color filter unit 225, and a white color filter unit 227 disposed in an array. However, the pixel group is not limited thereto, and the pixel group may include a color filter unit in yellow or another color.

In an embodiment of this application, a plurality of light-transmitting regions is formed in a direction of the scanning lines 120 and in a direction perpendicular to the scanning lines 120 on the light shielding layer 210. Each light-transmitting region includes two color filter units. A 4x^{th} color filter unit and a (4x+1)^{th} color filter unit along the scanning line 120 have a same color and are located in a same light-transmitting region, where x is a positive number. In FIG. 3, for example, two white color filter units 227 are disposed in a same light-transmitting region. However, the color filter units are not merely limited to white color filter units, and may alternatively be color filter units in another color. No light shielding layer is disposed between adjacent color filter units having a same color. For example, no light shielding layer is disposed between the white color filter units 227. This design can further reduce the area ratio of the light shielding layer 210 and increase the aperture ratio.

In some embodiments, the scanning lines 120 are disposed adjacent to each other, to share a same light shielding layer 210, so that an area ratio of the light shielding layer 210 to an entire display region can be reduced, thereby increasing the area of the light-transmitting regions and improving the aperture ratio.

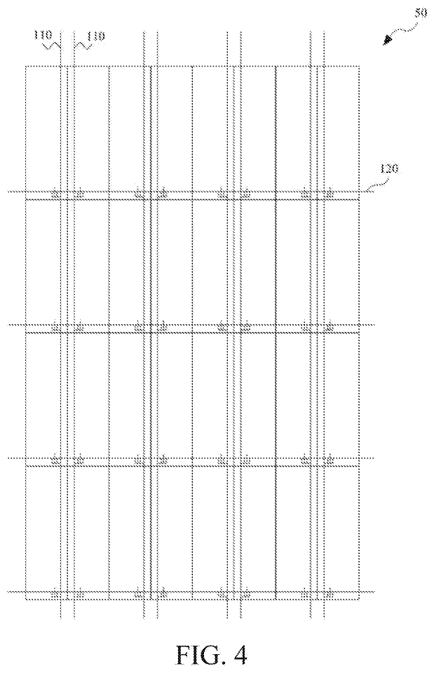

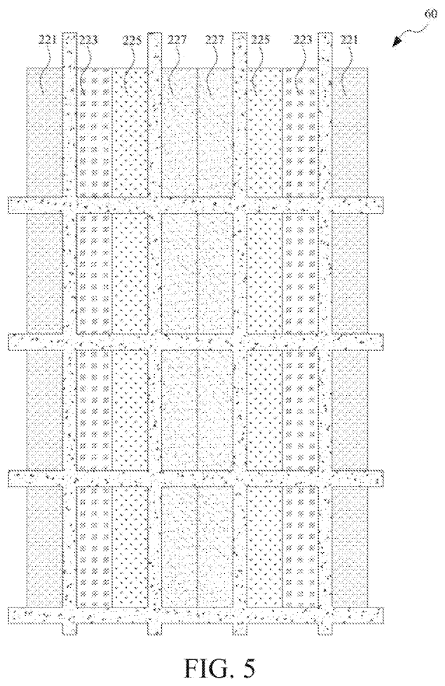

FIG. 4 is a schematic diagram of a pixel circuit according to another embodiment of this application, and FIG. 5 is a schematic diagram of a color filter layer according to another embodiment of this application. Referring to FIG. 4 and FIG. 5, in an embodiment of this application, a display panel includes: a first substrate (not shown); a second substrate (not shown), disposed opposite to the first substrate; a pixel circuit 50, including a plurality of conductive lines disposed on the first substrate, where a (2n−1)^{th} conductive line is disposed adjacent to a 2n^{th} conductive line, the 2n^{th} conductive line is disposed away from a (2n+1)^{th} conductive line, and n is a positive number; a color filter layer 60, including a plurality of pixel groups disposed in an array on the first substrate or the second substrate, where each pixel group includes four adjacent color filter units having different colors; and a light shielding layer 210, disposed between the color filter units and covering the conductive lines, where the light shielding layer 210 separates the plurality of color filter units.

In an embodiment of this application, adjacent color filter units of adjacent pixel groups have a same color. The conductive lines include a plurality of data lines 110 coupled to a source driver.

In an embodiment of this application, a plurality of light-transmitting regions is formed in a direction of the data lines 110 and in a direction perpendicular to the data lines 110 on the light shielding layer 210. Each light-transmitting region includes two color filter units. No light shielding layer 210 is disposed between two color filter units located in a same light-transmitting region. The data lines 110 are disposed adjacent to each other, to share a same light shielding layer 210, so that an area ratio of the light shielding layer 210 can be reduced.

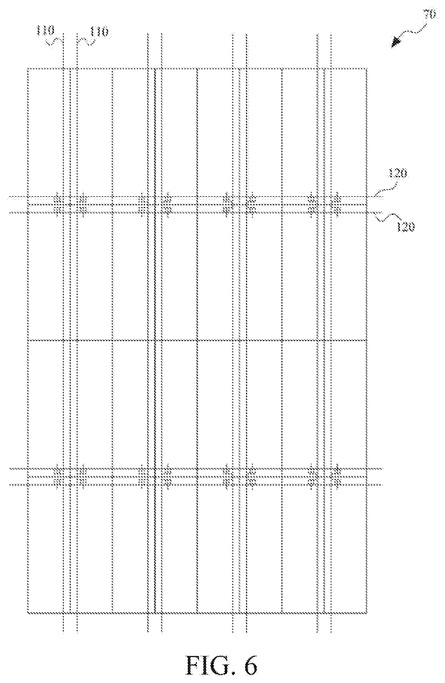

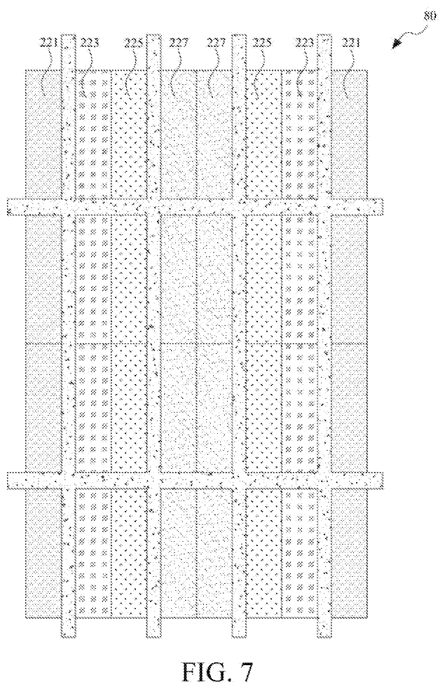

FIG. 6 is a schematic diagram of a pixel circuit according to still another embodiment of this application, and FIG. 7 is a schematic diagram of a color filter layer according to still another embodiment of this application. Referring to FIG. 6 and FIG. 7, in an embodiment of this application, a display panel includes: a first substrate (not shown); a second substrate (not shown), disposed opposite to the first substrate; a pixel circuit 70, including a plurality of conductive lines disposed on the first substrate, where a (2n−1)^{th} conductive line is disposed adjacent to a 2n^{th} conductive line, the 2n^{th} conductive line is disposed away from a (2n+1)^{th} conductive line, and n is a positive number; a color filter layer 80, including a plurality of pixel groups disposed in an array on the first substrate or the second substrate, where each pixel group includes four adjacent color filter units having different colors; and a light shielding layer 210, disposed between the color filter units and covering the conductive lines, where the light shielding layer 210 separates the plurality of color filter units. The conductive lines include a plurality of scanning lines 120 coupled to a gate driver and a plurality of data lines 110 coupled to a source driver.

In an embodiment of this application, a plurality of light-transmitting regions is formed in a direction of the scanning lines 120 and in a direction of the data lines 110 on the light shielding layer 210. Each light-transmitting region includes four color filter units. A 4x^{th} color filter unit and a (4x+1)^{th} color filter unit along the scanning line 120 have a same color a 4y^{th} color filter unit and a (4y+1)^{th} color filter unit along the data line 110 have a same color and are located in a same light-transmitting region, where x and y are positive numbers. No light shielding layer 210 is disposed between four color filter units located in a same light-transmitting region. The data lines 110 are disposed adjacent to each other and the scanning lines 120 are disposed adjacent to each other, to share a same light shielding layer 210. Compared with the foregoing embodiments, an area ratio of the light shielding layer 210 to an entire display region can be greatly reduced, thereby increasing the area of the light-transmitting regions and improving an aperture ratio.

In some embodiments, color filter units in the pixel group are arranged adjacent to each other in a left-right direction (horizontally arranged), that is, four color filter units having different colors are arranged adjacently along the scanning line. However, the arrangement manner is not limited thereto, and the color filter units in the pixel group may alternatively be arranged adjacent to each other in an up-down direction (vertically arranged), that is, four color filter units having different colors are arranged adjacently along the data line.

In some embodiments, adjacent pixel groups may be, for example, mirror symmetrical. By means of the symmetrical structure, adjacent color filter units of adjacent pixel groups may have a same color.

In some embodiments, the light shielding layer may be, for example, a black matrix, or another dark insulating material or low-reflective insulating material.

In some embodiments, the pixel circuits (30, 50, and 70) and the color filter layers (40, 60, and 80) may be disposed on different substrates, or may be disposed on a same substrate.

In some embodiments, the pixel group includes four color filter units having different colors. However, the pixel group may be applied to a display panel performing display by three colors, for example, an RGB display panel.

In some embodiments, for highlighting, the area of the light shielding layer 210 is enlarged and the display area of the color filter unit is reduced. However, this is not used as an area ratio of the light shielding layer 210 to the color filter units (221, 223, 225, and 227). The area ratio is determined according to a design of a designer and a process yield, and is not limited herein.

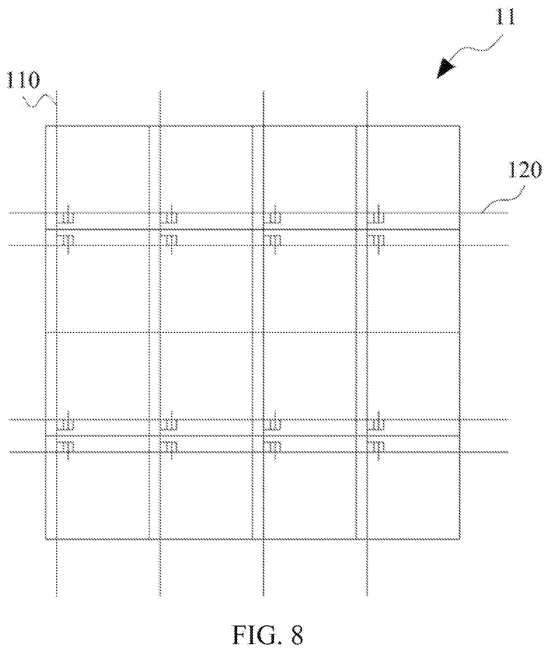

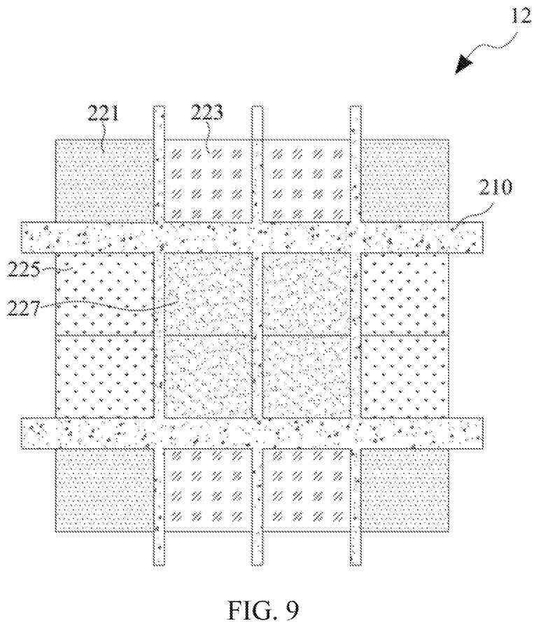

FIG. 8 is a schematic diagram of a pixel circuit according to an embodiment of this application and FIG. 9 is a schematic diagram of a color filter layer according to an embodiment of this application. Referring to both FIG. 8 and FIG. 9, in an embodiment of this application, a display panel includes: a first substrate (not shown); a second substrate (not shown), disposed opposite to the first substrate; a pixel circuit 11, including a plurality of data lines 110 and scanning lines 120 disposed on the first substrate, where a (2n−1)^{th} scanning line is disposed adjacent to a 2n^{th} scanning line, the 2n^{th} scanning line is disposed away from a (2n+1)^{th} scanning line, and n is a positive number; a color filter layer 12, including a plurality of pixel groups disposed in an array on the first substrate or the second substrate, where each pixel group includes a plurality of adjacent color filter units having different colors, the color filter units are arranged in a “ [symbol] ” shape, and the color filter units are square-shaped color resistors; and a light shielding layer 210, disposed between the color filter units and covering the data lines and the scanning lines, where the light shielding layer 210 separates the plurality of color filter units. Adjacent color filter units of adjacent pixel groups have a same color.

In an embodiment of this application, a plurality of light-transmitting regions is formed in a direction of the data lines 110 and in a direction perpendicular to the data lines 110 on the light shielding layer 210. Each light-transmitting region includes two color filter units. Because the pixel group is disposed in a “ [symbol] ” shape, a 2x^{th} color filter unit and a (2x+1)^{th} color filter unit along the data line 110 have a same color and are located in a same light-transmitting region, where x is a positive number. In FIG. 9, for example, color filter units 225 or color filter units 227 are disposed in a same light-transmitting region.

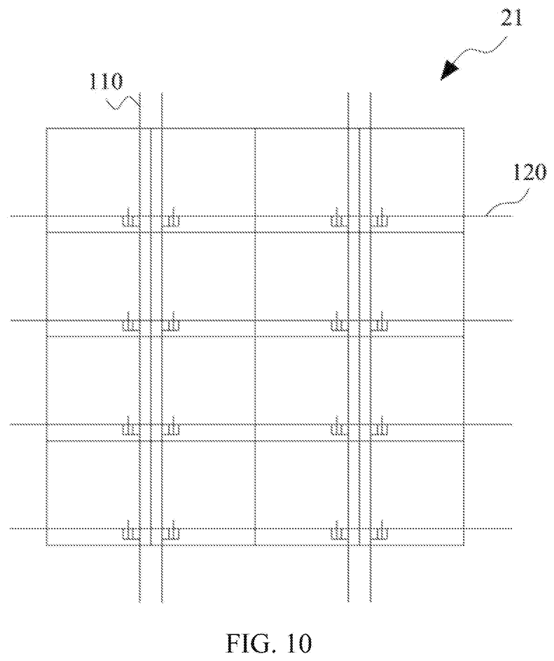

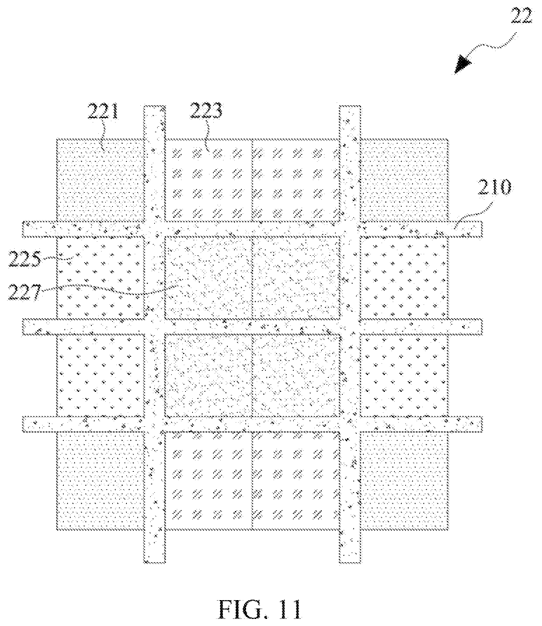

FIG. 10 is a schematic diagram of a pixel circuit according to an embodiment of this application and FIG. 11 is a schematic diagram of a color filter layer according to an embodiment of this application. Referring to both FIG. 10 and FIG. 11, in an embodiment of this application, a display panel includes: a pixel circuit 21, including a plurality of data lines 110 and scanning lines 120 disposed on a first substrate, where a (2n−1)^{th} data line is disposed adjacent to a 2n^{th} data line, the 2n^{th} data line is disposed away from a (2n+1)^{th} data line, and n is a positive number; a color filter layer 22, including a plurality of pixel groups disposed in an array on the first substrate or a second substrate, where each pixel group includes a plurality of adjacent color filter units having different colors, the color filter units are arranged in a “ [symbol] ” shape, and the color filter units are square-shaped color resistors; and a light shielding layer 210, disposed between the color filter units and covering the data lines and the scanning lines, where the light shielding layer 210 separates the plurality of color filter units. Adjacent color filter units of adjacent pixel groups have a same color.

In an embodiment of this application, a plurality of light-transmitting regions is formed in a direction of the scanning lines 120 and in a direction perpendicular to the scanning lines 120 on the light shielding layer 210. Each light-transmitting region includes two color filter units. A 2x^{th} color filter unit and a (2x+1)^{th} color filter unit along the scanning line 120 have a same color and are located in a same light-transmitting region, where x is a positive number. In FIG. 11, for example, color filter units 223 or color filter units 227 are disposed in a same light-transmitting region.

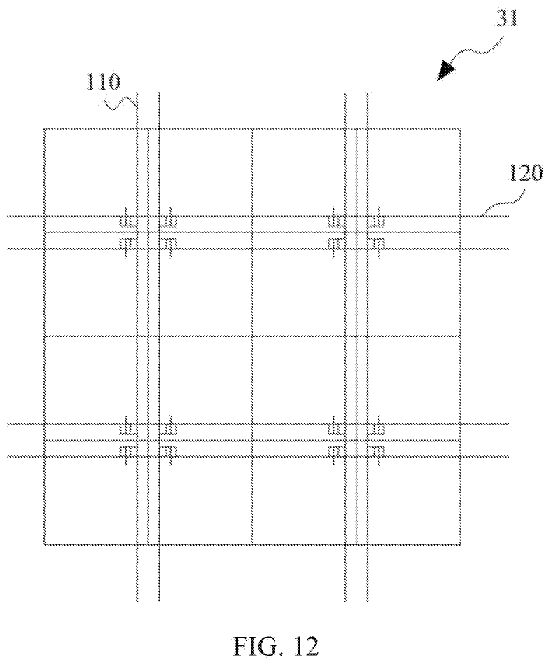

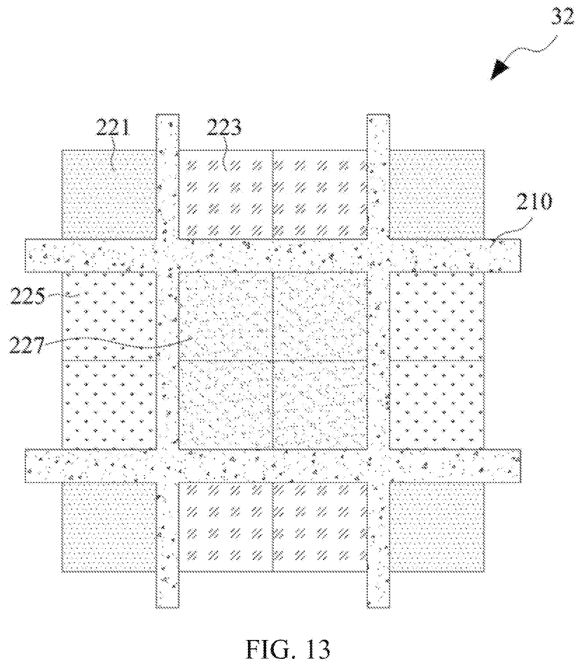

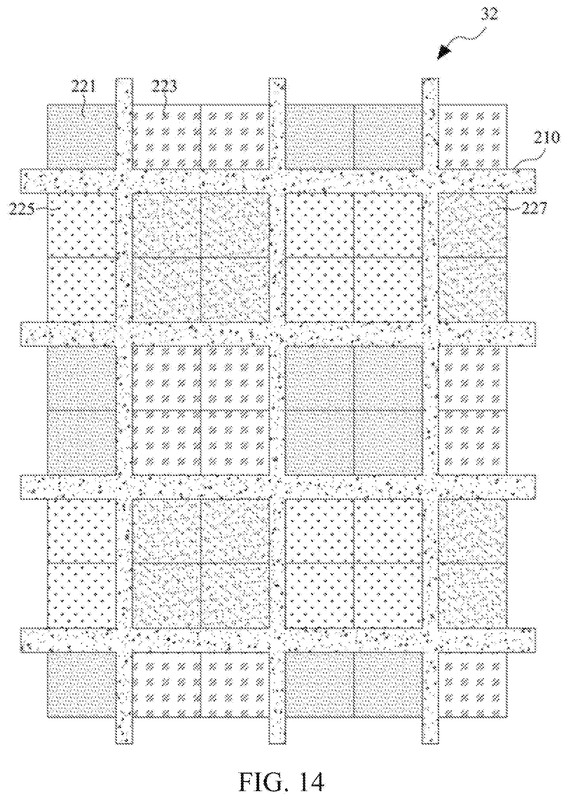

FIG. 12 is a schematic diagram of a pixel circuit according to an embodiment of this application, FIG. 13 is a schematic diagram of a color filter layer according to an embodiment of this application, and FIG. 14 is an extended schematic diagram of the color filter layer in FIG. 13. Referring to both FIG. 12 to FIG. 14, in an embodiment of this application, a display panel includes: a pixel circuit 31, including a plurality of data lines 110 and scanning lines 120 disposed on a first substrate, where a (2n−1)^{th} data line is disposed adjacent to a 2n^{th} data line, the 2n^{th} data line is disposed away from a (2n+1)^{th} data line, a (2m−1)^{th} scanning line is disposed adjacent to a 2m^{th} scanning line, the 2m^{th} scanning line is disposed away from a (2m+1)^{th} scanning line, and n and m are positive numbers; a color filter layer 32, including a plurality of pixel groups disposed in an array on the first substrate or a second substrate, where each pixel group includes a plurality of adjacent color filter units having different colors, the color filter units are arranged in a “ [symbol] ” shape, and the color filter units are square-shaped color resistors; and a light shielding layer 210, disposed between the color filter units and covering the data lines and the scanning lines, where the light shielding layer 210 separates the plurality of color filter units. Adjacent color filter units of adjacent pixel groups have a same color.

In an embodiment of this application, a plurality of light-transmitting regions is formed in a direction of the data lines 110 and in a direction of the scanning lines 120 on the light shielding layer 210. Each light-transmitting region includes four color filter units. A 2x^{th} color filter unit and a (2x+1)^{th} color filter unit along the scanning line 120 have a same color or a 2y^{th} color filter unit and a (2y+1)^{th} color filter unit along the data line 110 have a same color, and the four color filter units are located in a same light-transmitting region, where x and y are positive numbers. No light shielding layer 210 is disposed between four color filter units located in a same light-transmitting region (as shown in FIG. 13 and FIG. 14). The data lines 110 are disposed adjacent to each other and the scanning lines 120 are disposed adjacent to each other, to share a same light shielding layer 210. Compared with the foregoing embodiment in which color filter units are in a “ [symbol] ” shape, an area ratio of the light shielding layer 210 to an entire display region can be greatly reduced, thereby increasing the area of the light-transmitting regions and improving an aperture ratio.

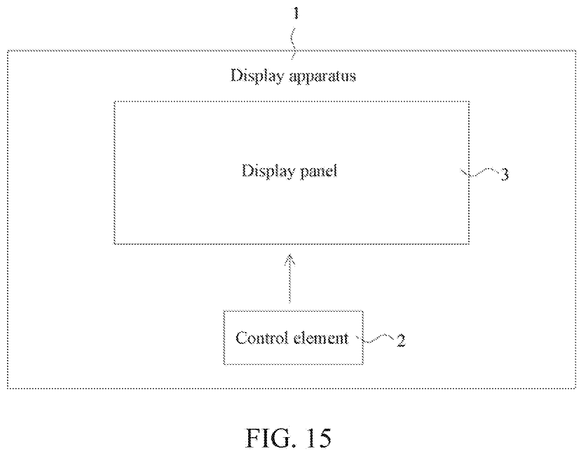

FIG. 15 is a block diagram of a display apparatus according to an embodiment of this application. Referring to FIG. 2 to FIG. 15, in an embodiment of this application, a display apparatus 1 includes a control element 2 and a display panel 3. The display panel 3 includes the pixel circuits (30, 50, 70, 11, 21, and 31) and the color filter layers (40, 60, 80, 12, 22, and 32) described in the foregoing embodiments.

In an embodiment of this application, the display panel may be, for example, a liquid crystal display panel, but is not limited thereto. The display panel may alternatively be an OLED display panel, a QLED display panel, a plasma display panel, a curved surface display panel, or a display panel of another type.

In this application, by means of configuration of data lines 110 and scanning lines 120 and an arrangement design of color filter units in each pixel group, an area ratio of a black matrix layer 210 to a display panel can be reduced, thereby improving an aperture ratio and a display effect of the display panel.

The wordings such as “in some embodiments” and “in various embodiments” are repeatedly used. The wordings usually refer to different embodiments, but they may also refer to a same embodiment. The words, such as “comprise”, “have”, and “include”, are synonyms, unless other meanings are indicated in the context thereof.

Descriptions above are merely preferred embodiments of this application, and are not intended to limit this application. Although this application has been disclosed above through the preferred embodiments, the embodiments are not intended to limit this application. A person skilled in the art can make some equivalent variations, alterations or modifications to the above-disclosed technical content without departing from the scope of the technical solutions of this application to obtain equivalent embodiments. Any simple alteration, equivalent change or modification made to the above embodiments according to the technical essence of this application without departing from the content of the technical solutions of this application shall fall within the scope of the technical solutions of this application.

What is claimed is:

1. A display panel, comprising:
a first substrate, wherein a plurality of active switches are disposed on the first substrate;
a second substrate, disposed opposite to the first substrate;
a plurality of conductive lines, disposed on the first substrate and coupled to the active switches, wherein a (2n−1)^{th} conductive line is disposed adjacent to a 2n^{th} conductive line, the 2n^{th} conductive line is disposed away from a (2n+1)^{th} conductive line, and n is a positive number;
a color filter layer, comprising a plurality of pixel groups disposed on the first substrate or the second substrate, wherein each pixel group comprises a plurality of adjacent color filter units having different colors; and
a light shielding layer, disposed between the color filter units and covering the conductive lines, wherein the light-shielding layer separates the color filter units;
wherein adjacent color filter units of adjacent pixel groups have a same color; and
wherein a distance between the 2n^{th} conductive line and the (2n+1)^{th} conductive line is longer than a distance between the (2n−1)^{th} conductive line and the 2n^{th} conductive line.

2. The display panel according to claim 1, wherein the conductive lines comprise a plurality of scanning lines coupled to a gate driver.

3. The display panel according to claim 2, wherein a plurality of light-transmitting regions is formed in a direction of the scanning lines and in a direction perpendicular to the scanning lines on the light shielding layer, and each light-transmitting region comprises two color filter units, wherein a 4x^{th} color filter unit and a (4x+1)^{th} color filter unit along the scanning line have a same color and are located in a same light-transmitting region, and x is a positive number.

4. The display panel according to claim 1, wherein the conductive lines comprise a plurality of data lines coupled to a source driver.

5. The display panel according to claim 4, wherein a plurality of light-transmitting regions is formed in a direction of the data lines and in a direction perpendicular to the data lines on the light shielding layer, and each light-transmitting region comprises two color filter units, wherein a 4y^{th} color filter unit and a (4y+1)^{th} color filter unit along the data line have a same color and are located in a same light-transmitting region, and y is a positive number.

6. The display panel according to claim 1, wherein the conductive lines comprise a plurality of scanning lines coupled to a gate driver and a plurality of data lines coupled to a source driver.

7. The display panel according to claim 6, wherein a plurality of light-transmitting regions is formed in a direction of the scanning lines and in a direction of the data lines on the light shielding layer, and each light-transmitting region comprises four color filter units, wherein a 4x^{th} color filter unit and a (4x+1)^{th} color filter unit along the scanning line have a same color or a 4y^{th} color filter unit and a (4y+1)^{th} color filter unit along the data line have a same color, and the four color filter units are located in a same light-transmitting region, wherein x and y are positive numbers.

8. The display panel according to claim 1, wherein no light shielding layer is disposed between adjacent color filter units having a same color.

9. The display panel according to claim 1, wherein adjacent pixel groups are mirror symmetrical.

10. The display panel according to claim 1, wherein a material of the light shielding layer is a dark light-absorbing material or a low reflective material.

11. The display panel according to claim 10, wherein the light shielding layer is a black matrix.

12. A display apparatus, comprising:
a control element, and
a display panel, comprising:
a first substrate, wherein a plurality of active switches are disposed on the first substrate;
a second substrate, disposed opposite to the first substrate;
a plurality of conductive lines, disposed on the first substrate and coupled to the active switches, wherein a (2n−1)^{th} conductive line is disposed adjacent to a 2n^{th} conductive line, the 2n^{th} conductive line is disposed away from a (2n+1)^{th} conductive line, and n is a positive number;
a color filter layer, comprising a plurality of pixel groups disposed on the first substrate or the second substrate, wherein each pixel group comprises a plurality of adjacent color filter units having different colors; and
a light shielding layer, disposed between the color filter units and covering the conductive lines, wherein the light-shielding layer separates the color filter units;
wherein adjacent color filter units of adjacent pixel groups have a same color; and
wherein a distance between the 2n^{th} conductive line and the (2n+1)^{th} conductive line is longer than a distance between the (2n−1)^{th} conductive line and the 2n^{th} conductive line.

13. The display apparatus according to claim 12, wherein the conductive lines comprise a plurality of scanning lines coupled to a gate driver.

14. The display apparatus according to claim 13, wherein a plurality of light-transmitting regions is formed in a direction of the scanning lines and in a direction perpendicular to the scanning lines on the light shielding layer, and each light-transmitting region comprises two color filter units, wherein a 4x^{th} color filter unit and a (4x+1)^{th} color filter unit along the scanning line have a same color and are located in a same light-transmitting region, and x is a positive number.

15. The display apparatus according to claim 12, wherein the conductive lines comprise a plurality of data lines coupled to a source driver.

16. The display apparatus according to claim 15, wherein a plurality of light-transmitting regions is formed in a direction of the data lines and in a direction perpendicular to the data lines on the light shielding layer, and each light-transmitting region comprises two color filter units, wherein a 4y^{th} color filter unit and a (4y+1)^{th} color filter unit along the data line have a same color and are located in a same light-transmitting region, and y is a positive number.

17. The display apparatus according to claim 12, wherein the conductive lines comprise a plurality of scanning lines coupled to a gate driver and a plurality of data lines coupled to a source driver.

18. The display apparatus according to claim 17, wherein a plurality of light-transmitting regions is formed in a direction of the scanning lines and in a direction of the data lines on the light shielding layer, and each light-transmitting region comprises four color filter units, wherein a 4x^{th} color filter unit and a (4x+1)^{th} color filter unit along the scanning line have a same color or a 4y^{th} color filter unit and a (4y+1)^{th} color filter unit along the data line have a same color, and the four color filter units are located in a same light-transmitting region, wherein x and y are positive numbers.

19. The display apparatus according to claim 12, wherein no light shielding layer is disposed between adjacent color filter units having a same color.

20. A display panel, comprising:
a first substrate, wherein a plurality of active switches are disposed on the first substrate;
a second substrate, disposed opposite to the first substrate;
a plurality of conductive lines, disposed on the first substrate and coupled to the active switches, wherein a (2n−1)^{th} conductive line is disposed adjacent to a 2n^{th} conductive line, the 2n^{t} conductive line is disposed away from a (2n+1)^{th} conductive line, and n is a positive number;
a color filter layer, comprising a plurality of pixel groups disposed on the first substrate or the second substrate, wherein each pixel group comprises four adjacent color filter units having different colors; and
a light shielding layer, disposed between the color filter units and covering the conductive lines, wherein the light-shielding layer separates the color filter units;
wherein adjacent color filter units of adjacent pixel groups have a same color;
wherein a distance between the 2n^{th} conductive line and the (2n+1)^{th} conductive line is longer than a distance between the (2n−1)^{th} conductive line and the 2n^{th} conductive line;
wherein color filter units in each pixel group are sequentially horizontally or vertically arranged along the conductive lines;
wherein the pixel group comprises a red color filter unit, a green color filter unit, a blue color filter unit, and a white color filter unit disposed in an array, and adjacent pixel groups are mirror symmetrical; and
wherein a material of the light shielding layer is a dark light-absorbing material or a low reflective material.
